(19) United States
(12) Patent Application Publication
(10) Pub. No.: US 2005/0201468 A1
(43) Pub. Date: Sep. 15, 2005

(54) Method and apparatus for interframe wavelet video coding

(75) Inventors: Sam S. Tsai, Hsinchu (TW); Hsueh-Ming Hang, Hsinchu (TW); Chia-Yang Tsai, Hsinchu (TW); Tihao Chiang, Hsinchu (TW)

Correspondence Address: TROXELL LAW OFFICE PLLC, SUITE 1404, 5205 LEESBURG PIKE, FALLS CHURCH, VA, 22041, US

(73) Assignee: National Chiao Tung University

(21) Appl. No.: 10/796,977

(22) Filed: Mar. 11, 2004

(51) Int. Cl. H04N 7/12

(52) U.S. Cl. 375/240.19; 375/240.18; 375/240.12; 375/240.16

(57) ABSTRACT

The present invention provides a method and apparatus for interframe wavelet video coding which comprises Motion Compensated Temporal Filtering and Discrete Wavelet Transform Coding to obtain: 1. compressed quantification error and scalability on temporal analysis and spatial analysis, and 2. scalability on Motion Information (MI) data so that the performance of wavelet video coding on low bitrate can be improved. A method for partitioned coding on MI is proposed: 1. to partitioned coding a motion vector according to the spatial block, the temporal frame, or the numeric precision; 2. to partition motion vectors to a plurality of layers, and, when the video bitstream changes, only the required MI is put into the final bitstream. Accordingly, the performance of wavelet video compression on low bitrate is greatly improved while the compression rate on high bitrate is only a little lower.

### FIELD OF THE INVENTION

The present invention relates to interframe wavelet video coding. More particularly, the present invention relates to a method and apparatus for interframe wavelet video coding with good video compression rate and scalability which can improve the scalability of the video compression rate and the performance of the Interframe Wavelet Video Coding on low bitrate.

### DESCRIPTION OF THE RELATED ART

As is known, the bitstream obtained by the related art of Interframe Wavelet Video Coding comprises two kind of information: 1. motion information (mainly the motion vector) and 2. wavelet transform coefficient and its related information. But now only the second kind of information is scalable and so the performance on low bitrate is not good.

Because the video scalability of the related art is mainly about the transformation factor and the wavelet factor that seem not enough when applying on low bitrate and the Motion Information (MI) still take a part in the whole bitstream, the present invention is to make MI to be scalable and to improve the performance of the Interframe Wavelet Video Coding on low bitrate.

Besides, there are mainly three kinds of video scalability: spatial scalability, temporal scalability and SNR scalability. The SNR scalability uses the feature on the bit plane to achieve gradual adjustment of the video frame.

### BRIEF SUMMARY OF THE INVENTION

Therefore, the main purpose of the present invention is to obtain good video compression rate and scalability on video coding so to improve the scalability of the video compression.

Another purpose of the present invention is to obtain scalability of the Motion Information (MI) to improve the performance of the Interframe Wavelet Video Coding on low bitrate.

To achieve the above purposes, the present invention comprises an encoder, a decoder and a puller to provide a video compression device capable of scalability which is to partition and encode MI to achieve scalability, and to transfer partitioned MI to a terminal according the scalability request so that the Ml is partitioned to be scalable and be coded according to the spatial precision, the temporal precision and the numerical precision; and the MI can accept a scalability request and corresponding MI data can be transferred after properly adjusting the above three precision. As a result, the present invention can have good video compression rate and scalability on video coding to improve the scalability of the video compression and the performance of the Interframe Wavelet Video Coding on low bitrate.

### BRIEF DESCRIPTION OF THE DRAWINGS

The present invention will be better understood from the following detailed description of preferred embodiments of the invention, taken in conjunction with the accompanying drawings, in which

FIG. 1 is a diagram of the method for video coding according to the present invention;

FIG. 2 is a flow chart for the motion estimator according to the present invention;

FIG. 3 is a flow chart for the Motion Information (MI) encoder according to the present invention;

FIG. 4 is a flow chart for the puller according to the present invention;

FIG. 5 is a flow chart for the MI decoder according to the present invention;

FIG. 6 is an example of the motion estimation according to the present invention; and

FIG. 7 is an example of the partitioned coding of the motion vector according to the present invention.

### DESCRIPTION OF THE PREFERRED EMBODIMENTS

The following descriptions of the preferred embodiment are provided to understand the features and the structures of the present invention.

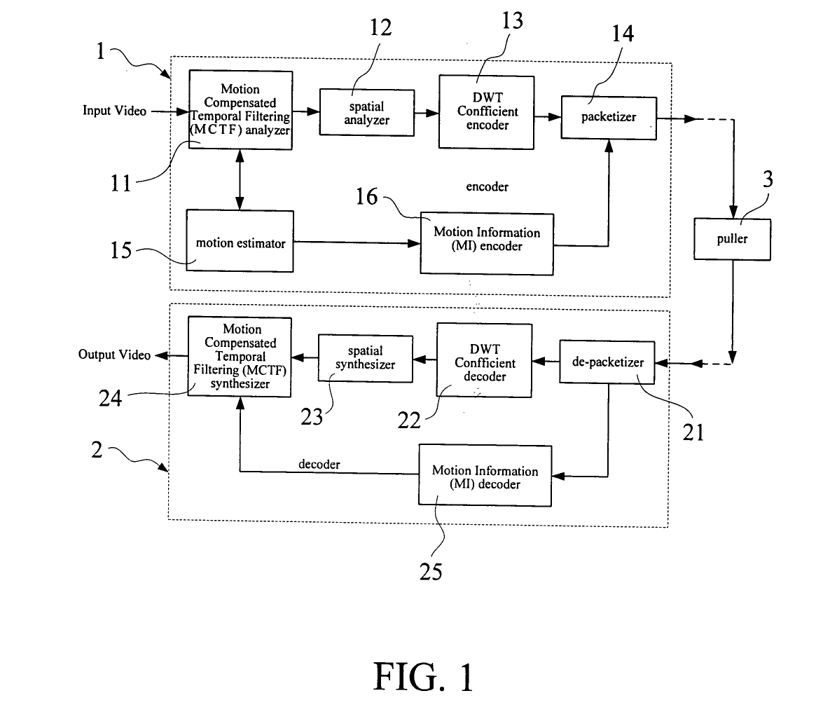

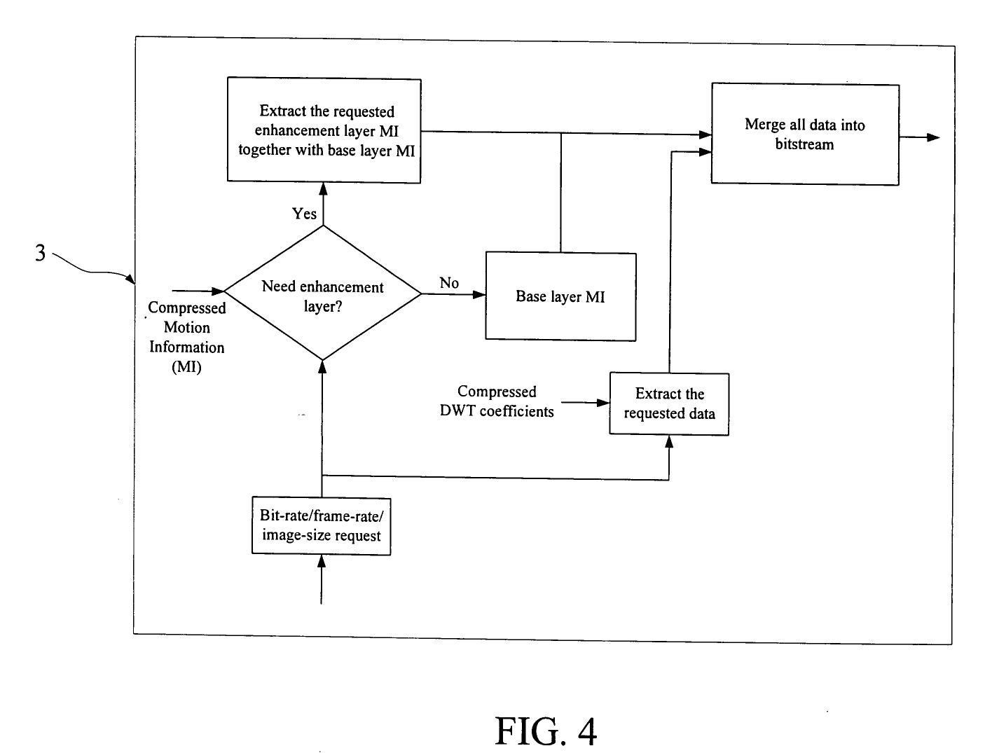

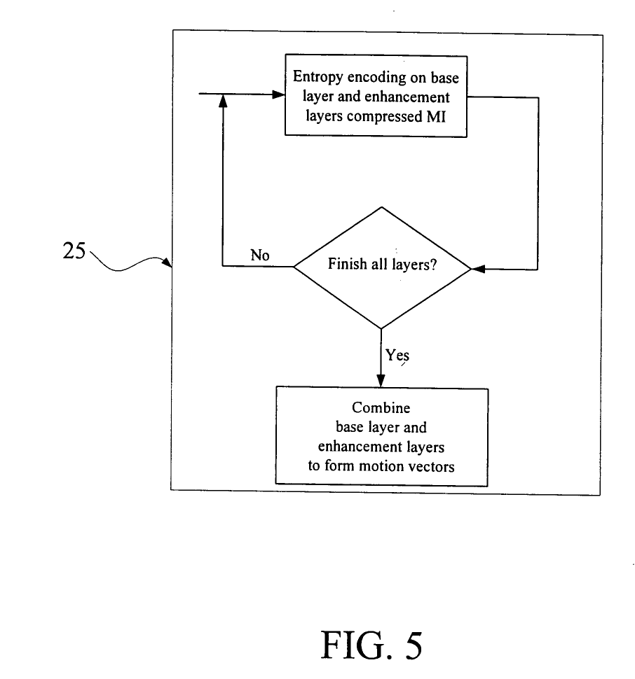

Please refer to FIG. 1 to FIG. 5, which are a diagram of the method for video coding, a flow chart for the motion estimator, a flow chart for the Motion Information (MI) encoder, a flow chart for the puller, and a flow chart for the MI decoder, according to the present invention. As shown in the figures, the present invention is a method and apparatus for interframe wavelet video coding with good video compression rate and scalable video coding to improve the scalability of the video compression and the performance of Interframe Wavelet Video Coding on low bitrate. The present invention comprises an encoder 1, a decoder 2, and a puller 3 connected to the encoder 1 and the decoder 3.

The encoder 1 is for video input which comprises the followings.

A Motion Compensated Temporal Filtering (MCTF) analyzer 11 is to analyze each video frame on temporal axis and decompose the video frame into high-pass frames of high frequency and low-pass frames of low frequency by using a motion vector obtained from a motion estimator 15, so that an output of temporal high-pass frames and temporal low-pass frames are obtained by an input of the original video frames.

A spatial analyzer 12 is connected to the MCTF analyzer 11 and is to decompose the temporal high-pass frames and the temporal low-pass frames into spatial high-pass frames and spatial low-pass frames through Discrete Wavelet Transform (DWT) method, so that an output of spatial high-pass frames and spatial low-pass frames is obtained through DWT method by an input of the temporal high-pass frames and the temporal low-pass frames.

A DWT coefficients encoder 13 is connected to the spatial analyzer 12 and is to perform an encoding in a compression way on the spatial high-pass frames and the spatial low-pass frames obtained by the spatial analyzer 12, so that, an output of a compressed video content bitstream is obtained by an input of the spatial high-pass frames and the spatial low-pass frames obtained through DWT method.

A packetizer 14 is connected to the DWT coefficient encoder 13 and is to bundle the compressed video content bitstream and a compressed MI into a single compound compressed bitstream, so that an output of the single compound compressed bitstream is obtained by an input of the compressed video content bitstream and the compressed MI.

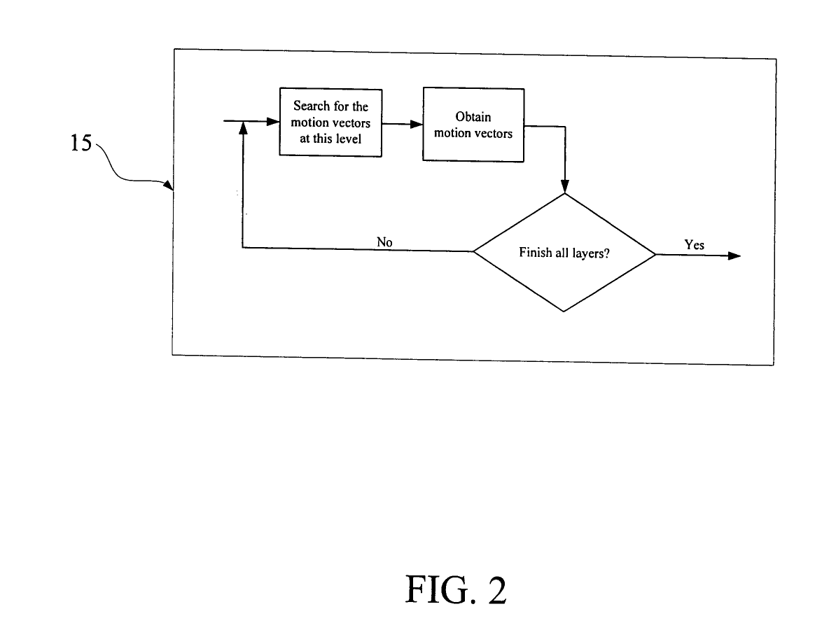

A motion estimator 15 is connected to the MCTF analyzer 11 and is to search for the motion vector for each partition of the video frame and continuously search through all partitions (as shown in FIG. 2) and a compression is obtained by recording as a motion vector the corresponding block address of the minimal difference according to the relationship between two or more selected frames, so that an output of an MI is obtained by an input of the two or more selected frames.

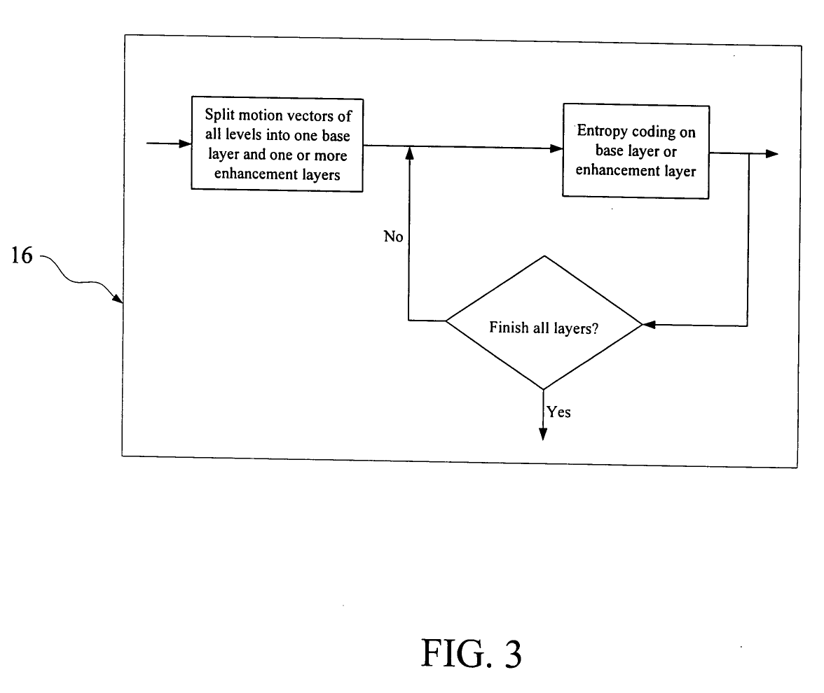

And an MI encoder 16 is connected to the packetizer 14 and the motion estimator 15 and is to split all motion vectors of all partitions into a base layer and a few enhancement layers and to apply entropy coding on the base layer and the enhancement layers (as shown in FIG. 3) to compress the MI, so that an output of a compressed MI is obtained by an input of the MI.

Therein, the MI encoder 16 is to do partitioned coding to the MI according to three precisions of spatial precision, temporal precision, or numerical precision.

And, the spatial precision is a partitioned motion block.

And, the temporal precision is a number of frames per second.

And, the numerical precision is a precision of the arithmetic expression of a motion vector.

And, the MI encoder 16 is to help compress related information of the motion estimator 15.

The decoder 2 is for video output which comprises the followings.

A de-packetizer 21 is connected to the puller 3 and is to split a compound bitstream into a compressed video content bitstream and a compressed MI.

A DWT coefficient decoder 22 is connected to the de-packetizer 21 and is to apply compressed decoding on the spatial high-pass frames and the spatial low-pass frames that are obtained by the spatial analyzer 12, so that an output of the spatial high-pass frames and the spatial low-pass frames is obtained by an input of a compressed video content bitstream.

A spatial synthesizer 23 is connected to the DWT coefficient decoder 22 and is to rebuild temporal high-pass frames and temporal low-pass frames from the spatial high-pass frames and the spatial low-pass frames through Inverse Discrete Wavelet Transform (IDWT) method, so that an output of the temporal high-pass frames and the temporal low-pass frames is obtained through IDWT method by an input of the spatial high-pass frames and the spatial low-pass frames.

An MCTF synthesizer 24 is connected to the spatial synthesizer 23 and is to synthesize the temporal high-pass frames and the temporal low-pass frames into a video frame by using motion vectors, so that an output of the video frame is obtained by an input of the temporal high-pass frames and the temporal low-pass frames obtained through IDWT method.

And an MI decoder 25 is connected to the de-packetizer 21 and the MCTF synthesizer 24 and is to apply entropy decoding on the compressed MI and combine a base layer and one or more enhancement layers to form a motion vector, so that, through applying entropy decoding to a compressed MI, an output of an MI is obtained by an input of the compressed MI.

The puller 3 is connected to the encoder 1 and the decoder 2 and is to read bit-rate/frame-rate/image-size information to partition a compressed video content bitstream; to decide whether one or more enhancement layers are needed on the bit-rate/frame-rate/image-size; to send the MI of a base layer; and to combine the partitioned compressed video content bitstreams and a partitioned MI obtained by partitioning the MI of the enhancement layers according to the bit-rate/frame-rate/image-size, to form a compressed bitstream (as shown in FIG. 3).

Therein, the method and apparatus is to partition an MI for scalability and to transfer a partition of the MI to a terminal to achieve the scalability.

The present invention of method and apparatus for interframe wavelet video coding is a method and apparatus to partition an MI to achieve scalability which applies partitioned encoding on an MI encoder 16 according to three precisions of spatial precision, temporal precision, and numerical precision and transfers data corresponding to the MI to achieve scalability of the MI after properly tuning the above three precisions.

Therein, the spatial precision is a partitioned motion block; the temporal precision is a number of frames per second; the numerical precision is a precision of the arithmetic expression of a motion vector; and the scalability is a capability of accepting demands according to one factor or a plurality of factors among bit-rate/frame-rate/image-size and the above three precisions.

And, the MI is a motion vector with the related data that helps to rebuild the motion vector.

And, the video compressing method can be an Interframe Wavelet Video Coding method or a video encoding method with motion information.

Accordingly, a novel method and apparatus for interframe wavelet video coding is obtained.

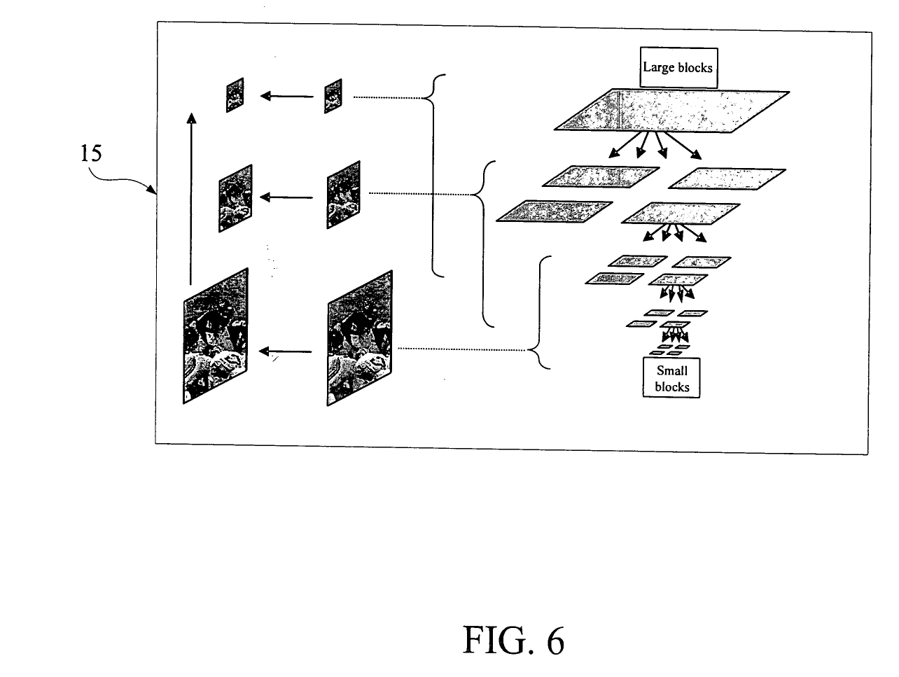

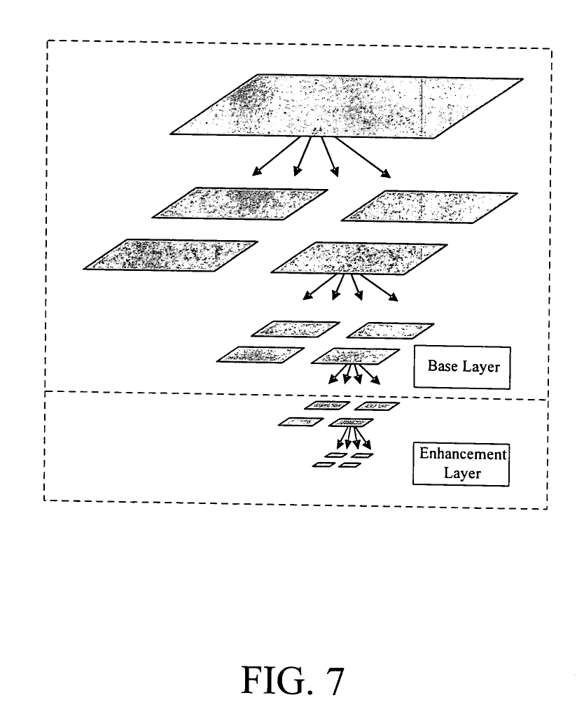

Please refer to FIG. 6 and FIG. 7, which are an example of the motion estimation and an example of the partitioned coding of the motion vector according to the present invention. As shown in the figures, the first step of MI encoding is to apply multiple-level motion estimation in the original coding process by the motion estimator, whose main purpose is to obtain motion vectors for different levels (of numerical precision or block size). As shown in the example of FIG. 6, motion vectors for a variety of block sizes can be found with different numerical precision. Scalability can be achieved by using this scaling in the next step.

The second step is to do partitioned encoding by MI encoder 16. The motion vectors for the various levels obtained in the previous step are partitioned and encoded here. To achieve scalability, in the pull process, the puller 3 will decide the data size to be transferred according to the requested data amount (ex. based on bit-rate/frame-rate/image-size request) needed. So, motion vectors are partitioned, and total levels to be transferred is decided according to data amount needed. As shown in the example of FIG. 7, the motion vectors of various levels as shown in the example of step 1 can be partitioned into two or more layers. A certain number of levels of bigger motion vector blocks become the base layer which is the basic motion vector that must be transferred. The smaller motion vector blocks become one or more the enhancement layers which can be transferred or left out according to data amount requested.

The third step is to write partitioned motion vectors to compressed bitstreams. Take the example in step 2 as an example, the motion vectors of the base layer and one or more enhancement layers are encoded separately and is written to the bitstreams.

The pull process of the puller 3 comprises the following steps.

Firstly, the compressed bitstreams is partitioned according to the bit-rate/frame-rate/image-size provided by the system. According to the bit-rate/frame-rate/image-size provided by the system, if the bit-rate/frame-rate/image-size is high, the base layer and several enhancement layers are transferred; but, if the bit-rate/frame-rate/image-size is low, only the base layer is transferred. By doing so, scalability can be achieved as requested by the system.

Secondly, the partitioned bitstreams are combined to form a new compressed bitstream. The final partitioned motion vector bitstream and the partitioned compressed video content bitstream is combined to a new bitstream which conforms to the data amount requested by the system.

After the pull process of the puller, the motion vectors obtained is read for decoding. In the present invention, the decoder will read the motion vectors after the pull process which can be the base layer or the base layer together with one or more enhancement layers.

Accordingly, the present invention is capable of achieving the followings:
1. At low bitrate, the channel bandwidth temporally changes, and, by using the scalability of the Interframe Wavelet Video Coding and the scalability of the MI, the compressed video frame data is smoothly transferred while the quality remains.
2. In a video conference, when a hand-held device is used as a terminal, because the hard ware capability is not strong enough, the online compression-decompression can only be achieved on lower bitrate transference, and a better scalability can be achieved by using the present invention together with the related art of Interframe Wavelet Video Coding.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

1. a method and apparatus for interframe wavelet video coding, comprising:
an encoder for inputting a video frame, comprising a Motion Compensated Temporal Filtering (MCTF) analyzer, a spatial analyzer connected to said MCTF analyzer, a Discrete Wavelet Transform (DWT) coefficient encoder connected to said spatial analyzer, a packetizer connected to said DWT coefficient encoder, a motion estimator connected to said MCTF analyzer, and a Motion Information (MI) encoder connected to said packetizer and said motion estimator;
a decoder for outputting a video frame, comprising a de-packetizer, a DWT coefficient decoder connected to said de-packetizer, a spatial synthesizer connected to said DWT coefficient decoder, an MCTF synthesizer connected to said spatial synthesizer, and an MI decoder connected to said de-packetizer and said MCTF synthesizer; and
a puller connected to said encoder and said decoder,
wherein said method and apparatus is to partition an MI for scalability and to transfer a partition of said MI to a terminal to achieve said scalability.

2. The method and apparatus for interframe wavelet video coding according to claim 1,
wherein said MCTF analyzer is to analyze said video frame on temporal axis and decompose said video frame into high-pass frames of high frequency and low-pass frames of low frequency by using a motion vector obtained from said motion estimator so that
an output of temporal high-pass frames and temporal low-pass frames is obtained by an input of said video frame.

3. The method and apparatus for interframe wavelet video coding according to claim 1,
wherein said spatial analyzer is to decompose temporal high-pass frames and temporal low-pass frames into spatial high-pass frames and spatial low-pass frames through Discrete Wavelet Transform (DWT) method so that
an output of said spatial high-pass frames and said spatial low-pass frames is obtained through DWT method by an input of said temporal high-pass frames and said temporal low-pass frames.

4. The method and apparatus for interframe wavelet video coding according to claim 1,
wherein said DWT coefficient encoder is to encode said video frame in a compression way on spatial high-pass frames and spatial low-pass frames that are obtained by said spatial analyzer so that
an output of a compressed video content bitstream is obtained by an input of said spatial high-pass frames and said spatial low-pass frames that are obtained through DWT method.

5. The method and apparatus for interframe wavelet video coding according to claim 1,
wherein said packetizer is to bundle a compressed video content bitstream and a compressed MI into a single compound compressed bitstream so that
an output of said single compound compressed bitstream is obtained by an input of said compressed video content bitstream and said compressed MI.

6. The method and apparatus for interframe wavelet video coding according to claim 1,
wherein said motion estimator is to search for the motion vector of each said partition and continuously search through all said partitions and a compression is obtained by recording as a motion vector the corresponding block address of the minimal difference according to the relationship between two or more selected frames so that
an output of an MI is obtained by an input of said two or more selected frames.

7. The method and apparatus for interframe wavelet video coding according to claim 1,
wherein said MI encoder is to split all motion vectors of all said partitions into a base layer and one or more enhancement layers and to apply entropy coding on said base layer and said enhancement layers to compress said MI applied with entropy coding so that
an output of a compressed MI is obtained by an input of said MI.

8. The method and apparatus for interframe wavelet video coding according to claim 1,
wherein said MI encoder is to do partitioned coding to said MI according to three precisions of spatial precision, temporal precision, or numerical precision.

9. The method and apparatus for interframe wavelet video coding according to claim 8,
wherein said spatial precision is a partitioned motion block.

10. The method and apparatus for interframe wavelet video coding according to claim 8,
wherein said temporal precision is a number of frames per second.

11. The method and apparatus for interframe wavelet video coding according to claim 8,
wherein said numerical precision is a precision of the arithmetic expression of a motion vector.

12. The method and apparatus for interframe wavelet video coding according to claim 1,
wherein said MI decoder is to help rebuild related information of said motion estimator.

13. The method and apparatus for interframe wavelet video coding according to claim 1,
wherein said DWT coefficient decoder is to apply compressed decoding on spatial high-pass frames and spatial low-pass frames that are obtained by said spatial analyzer so that
an output of said spatial high-pass frames and said spatial low-pass frames is obtained by an input of a compressed video content bitstream.

14. The method and apparatus for interframe wavelet video coding according to claim 1,
wherein said spatial synthesizer is to rebuild temporal high-pass frames and temporal low-pass frames from spatial high-pass frames and spatial low-pass frames through Inverse Discrete Wavelet Transform (IDWT) method so that
an output of said temporal high-pass frames and said temporal low-pass frames is obtained through IDWT method by an input of said spatial high-pass frames and said spatial low-pass frames.

15. The method and apparatus for interframe wavelet video coding according to claim 1,
wherein said MCTF synthesizer is to synthesize temporal high-pass frames and temporal low-pass frames into a video frame by using motion vectors so that
an output of a video frame is obtained by an input of said temporal high-pass frames and said temporal low-pass frames obtained through IDWT method.

16. The method and apparatus for interframe wavelet video coding according to claim 1,
wherein said MI decoder is to apply entropy decoding on said compressed MI and combine a base layer and one or more enhancement layers to form a motion vector so that
an output of an MI is obtained by an input of a compressed MI applied with entropy decoding.

17. The method and apparatus for interframe wavelet video coding according to claim 1,
wherein said puller is to read bit-rate/frame-rate/image-size information to partition a compressed video content bitstream; to decide whether one or more enhancement layers are needed on said bit-rate/frame-rate/image-size; to send the MI of a base layer; and to combine said partitioned compressed video content bitstream and a partitioned MI obtained by partitioning the MI of said enhancement layers according to said bit-rate/frame-rate/image-size, to form a compressed bitstream.

18. A method and apparatus for interframe wavelet video coding, comprising a plurality of steps of:
applying partitioned encoding on an MI encoder according to three precisions of spatial precision, temporal precision, and numerical precision; and
transferring data corresponding to said MI to achieve scalability of said MI by tuning said three precisions.

19. The method and apparatus for interframe wavelet video coding according to claim 18,
wherein said spatial precision is a partitioned motion block.

20. The method and apparatus for interframe wavelet video coding according to claim 18,
wherein said temporal precision is a number of frames per second.

21. The method and apparatus for interframe wavelet video coding according to claim 18,
wherein said numerical precision is a precision of the arithmetic expression of a motion vector.

22. The method and apparatus for interframe wavelet video coding according to claim 18,
wherein said scalability is a capability of accepting demands according to one factor or a plurality of factors among bit-rate/frame-rate/image-size and said three precisions.

23. The method and apparatus for interframe wavelet video coding according to claim 18,
wherein said MI is a motion vector and related data that helps to rebuild said motion vector.

24. The method and apparatus for interframe wavelet video coding according to claim 18,
wherein said video compressing method is an Interframe Wavelet Video Coding method.

25. The method and apparatus for interframe wavelet video coding according to claim 18,
wherein said video compressing method is a video encoding method with motion information.
